(19) United States
(12) Patent Application Publication
(10) Pub. No.: US 2008/0076023 A1
(43) Pub. Date: Mar. 27, 2008

(54) Lithium cell

(76) Inventor: Hiroyuki Yumoto, Fishers, IN (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/903,400

(22) Filed: Sep. 21, 2007

Related U.S. Application Data
(60) Provisional application No. 60/846,320, filed on Sep. 21, 2006.

(51) Int. Cl. H01M 2/02; H01M 2/30

(52) U.S. Cl. 429/178; 429/163

(57) ABSTRACT

A lithium cell (cell) suitable for use in a battery pack comprises a housing, first and second electrodes of opposite charge disposed and spaced from each other in the housing. The first electrode comprises a first active component and the second electrode comprises a second active component different from the first active component. The cell further comprises first and second current collectors disposed and spaced from each other in the housing. The first and second current collectors are in electrical communication with the first and second electrodes, respectively. The cell further comprises a separator disposed in the housing between the first and second electrodes.

### CROSS REFERENCE TO RELATED APPLICATIONS

This application claims the benefit of U.S. Provisional Patent Application Ser. No. 60/846,320 filed on Sep. 21, 2006 and incorporated herewith in its entirety.

### FIELD OF THE INVENTION

The present invention generally relates to a lithium cell, and, more specifically, to lithium-ion cell.

### DESCRIPTION OF THE RELATED ART

Lithium-ion cells, sometimes called Li-ion cells, are a type of secondary, i.e., rechargeable, battery commonly used in consumer electronics. They are currently one of the most popular types of battery for portable electronics, with one of the best energy-to-weight ratios, no memory effect, and a slow loss of charge when not in use. Lithium-ion batteries can be formed into a wide variety of shapes and sizes so as to efficiently fill available space in the devices they power. With their high energy density, lithium-ion cells are being developed for applications in hybrid electric vehicles (HEVs) and electric vehicles (EVs).

The anode of a conventional Li-ion cell is typically made from carbon, the cathode from a metal oxide, and the electrolyte is a lithium salt in an organic solvent. Liquid electrolytes in Li-ion batteries consist of solid lithium-salt electrolytes, such as LiPF₆, LiBF₄, or LiClO₄, and organic solvents, such as ether. A liquid electrolyte conducts Li ions, which act as a carrier between the cathode and the anode when a battery passes an electric current through an external circuit. In certain lithium-ion cells, lithium ions move between the positive and negative electrode plates, and these are called rocking chair cells.

Many lithium-ion cells contain such negative electrode plates, positive electrode plates, and if needed a separator between them and have a wound or laminated structure with electrolyte solution poured into the structure, sealed into a metal or metal laminate case. Copper foil is commonly used for collectors of the negative electrode plate. A slurry of active material, bonder or adhesive, and if needed a conduction aid, is coated on the copper foil, dried and pressed to obtain a negative electrode plate.

Usually, completely discharged active material is used in the negative electrode plate. In the case of active material such as graphite, etc., immediately after assembly, the negative electrode potential may be higher than the corrosion potential of the copper foil. Thus, for suppressing the copper foil negative electrode, a process of lowering the negative electrode potential may be necessary. This process is highly critical in terms of cost. Such phenomenon occurs not only in the production step. During abusive over-discharge, the potential of the negative electrode may increase above the corrosion potential of copper, causing serious problems.

In the United States Publication No. 24157124A1, a method for preventing the negative electrode potential increasing above the corrosion potential by doping the positive electrode side was presented. In this method, the balance of the positive and negative electrodes is critical. There is still a question of whether this method is effective for worn negative electrode plates after a long-term usage with this balance destroyed. In Japanese Patent Reference No. JP3030996, a lithium foil is adhered to the negative electrode; thus, lithium ions are completely depleted from the negative electrode with extreme lowering of the negative electrode potential. The lithium ion cells have improved safety with removal of lithium metal from the system; thus, adding lithium foil into the system is not a welcome solution.

One of the big hindrances in developing lithium secondary cells is the lithium dendrite formation during charging. This occurs when lithium foil is used in the negative electrode, with lithium dendrite formation on the negative electrode during charging, finally lithium protruding through the separator, reaching the positive electrode and leading to shorting. In the worst case, this phenomenon causes severe thermal runaway reactions in the cell, leading to significant capacity reduction and, ultimately, to the sudden death of the cell by fire or explosion.

This problem is mostly solved by using lithium ion-storing material as the negative electrode as opposed to lithium metal, as disclosed in the U.S. Pat. No. 5,196,279 to Tarascon. Carbon and graphite are commonly used as lithium-storing active materials. Such materials store and release lithium ions at a potential very close to 0.1V vs. Li, and are very effective negative electrode active materials with very high energy. However, because this potential is very close to that of metallic lithium, even the slightest increase in resistance can cause metallic lithium to readily plate out on the negative electrode. Such a problem may also be encountered when the negative electrode is deteriorated upon extended use and low-temperature use. Also, when the releasable lithium content of the positive electrode exceeds the storage content of the negative electrode, lithium is deposited in overcharging. With lamellar lithium transition metal oxides such as LiNiO₂ and LiCoO₂, the releasable lithium content of the positive electrode is often made higher than the storage capacity of the negative electrode.

In overcharging, the negative electrode potential decreases significantly, resulting in reductive decomposition of the electrolyte with adverse effects on safety such as gas generation, etc. It seems that such reductive decomposition of electrolyte is further accelerated by the deposition of lithium with large surface area. Solid electrolyte interface layer (SEI layer) formed by the reductive decomposition of electrolyte is present on the negative electrode plate surface, and this SEI layer seems to prevent further reductive decomposition of the electrolyte. In overcharging, an increase of temperature causes decomposition of the SEI layer. Once the SEI is broken down, decomposition of the electrolyte occurs continuously on the negative electrode.

Furthermore, in overcharging, the positive electrode potential also increases significantly, resulting in oxidative decomposition of electrolyte releasing oxygen gas by decomposition of the active material. Such active material decomposition is accompanied by significant heat generation, and the entire cell runs hot, potentially causing an explosion.

In the case of using near 100% lithium, as in the case of LiMn₂O₄ and LiFePO₄, by design, the lithium storage content of the positive electrode can be smaller than the storage content of the negative electrode. Therefore, cells employing these active materials on the positive electrode and standard negative electrode materials will yield a safer cell, with respect to overcharge. Once the lithium content of the positive is charged into the negative electrode, there is no more lithium left in the cell to cycle. This is unlike the LiCoO₂ or LiNiO₂, where there is a finite amount of Li remaining within the positive electrode structure, resulting in plating of Li on the negative electrode.

In U.S. Pat. No. 5,591,546 to Nagaura, active material having a spinel structure is used on both the positive and negative electrodes. This proposes a simple combination of the positive and negative electrodes, and this patent does not solve the safety problems of cells. As explained earlier, when lithium discharge from the positive electrode exceeds the storage capacity of lithium of the negative electrode, lithium deposition occurs, damaging the safety in overcharging.

In Japanese Patent Laid-Open No. 10-027627 (1998), the over-discharge problem is solved by using cells using metallic lithium and Li₄Ti₅O₁₂. However, this is not effective against overcharging.

When both high voltage and high current are needed, especially in electric vehicle applications, many cells are used in combination as a battery pack. In the case of lithium ion cells, because safety in overcharging and over-discharging cannot be maintained for each cell, functions monitoring current and voltage of each cell and functions preventing overcharging and over-discharging are installed as a battery management system (BMS). Solving the safety in overcharging and over-discharging at the same time provides not only a simple quality improvement, but also a highly critical improvement in terms of production cost and BMS cost in battery pack.

In the U.S. Pat. No. 6,274,271 to Koshiba, et al., the positive electrode plate-negative electrode plate capacity balance was shifted to higher positive electrode plate, and an additive was added to the negative electrode to maintain the potential above 0.15V even in overcharging. Since no excess lithium is present during over-discharge, cells with high safety even in over-discharging are expected. However, the negative electrode potential may still rise above the corrosion potential of copper foil. Since 0.15V is very close to 0V, in operations requiring high resistance and high current at low temperature as would be expected in electric vehicle applications, there is a danger that in voltage depression by resistance x current, the negative electrode potential may decrease below 0V, resulting in deposition of lithium. The additives are not used in the usual cell cycling and are thus useless in normal operating conditions. These additives therefore cause an energy density decrease and material cost increase.

Accordingly, there remains an opportunity to provide a lithium cell that overcomes many of the aforementioned issues.

### SUMMARY OF THE INVENTION AND ADVANTAGES

The present invention provides a lithium cell suitable for use in a battery pack. The lithium cell comprises a housing. The lithium cell further comprises first and second electrodes disposed and spaced from each other in the housing and having opposite charges. The first electrode comprises a first active component and the second electrode comprises a second active component different from the first active component. The lithium cell further comprises first and second current collectors disposed and spaced from each other in the housing. The first and second current collectors are in electrical communication with the first and second electrodes, respectively. The cell further comprises a separator disposed in the housing between the first and second electrodes. At least one of the first and second electrodes further comprises an additive for maintaining a potential of the lithium cell in a range of from about 0.5V to about 1.5V and for preventing the potential from dropping below about 0.5V.

The lithium cell of the present invention has excellent overcharging and over-discharging properties.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a cross-sectional view of a lithium cell of the present invention.

### DETAILED DESCRIPTION OF THE INVENTION

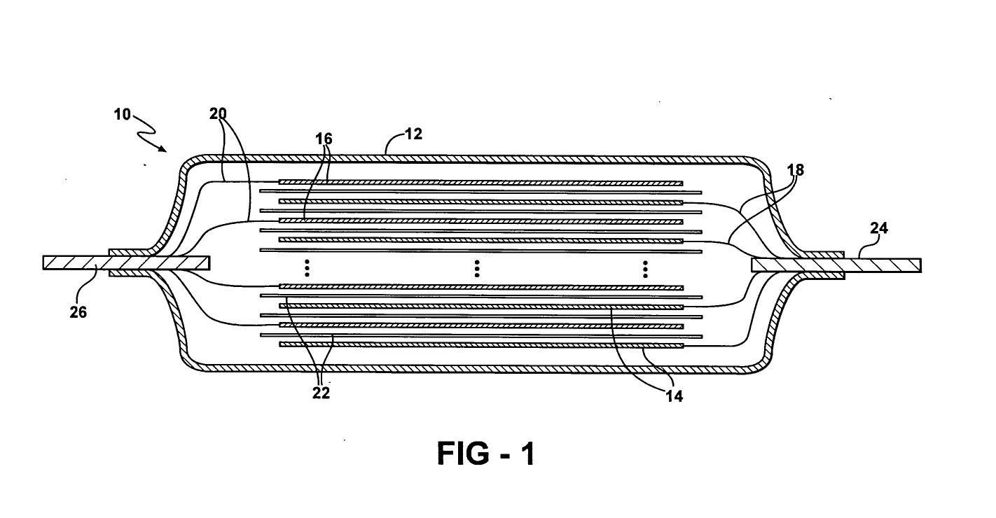

Referring to the Figures, wherein like numerals indicate like or corresponding parts, a lithium cell is shown generally at 10 in FIG. 1. The lithium cell 10, hereinafter referred to as the cell 10, may be used in various industries and for various applications. The cell 10 is especially suitable for use in a battery pack (not shown). The cell 10 may also be referred to as a lithium-ion cell 10. The cells 10 of the present invention have improved safety in overcharging and over-discharging relative to conventional lithium cells. The cells 10 of the present invention are especially effective as high-output cells, and can be used in a hybrid electric vehicle (HEV) or an electric vehicle (EV). The cells 10 of the present invention may also be used at low temperatures, and can be produced with improved energy density, increased productivity and cost reduction.

The cell 10 comprises a housing 12. The housing 12, and therefore the cell 10, can be configured into various sizes and shapes. In one embodiment, the housing 12 is an envelope of rectangular configuration having a first terminal and a second terminal opposite the first terminal and spaced by side edges with each of the first and second terminals defining at least one opening. The housing 12 may be made of various materials known to those skilled in the battery art, such as a metal or a metal laminate.

A first electrode 14, typically a positive electrode 14, is disposed in the housing 12. The first electrode 14 comprises a first active component. The first active component is typically a lithium ion-storing active material, which can generally utilize 100% of the available lithium within the normal voltage range of the material. In certain embodiments, the first active component comprises at least one of LiMn₂O₄, LiCoO₂, LiNiO₂, and LiFePO₄. In one embodiment, the first active component is LiMn₂O₄. A transition metal site of the first active component may be doped, for example, with titanium, aluminum, magnesium, nickel, manganese, etc.

A second electrode 16, typically a negative electrode 16, is disposed in the housing 12 and is spaced from the first electrode 14. As alluded to above, the second electrode 16 has an opposite charge from that of the first electrode 14. The second electrode 16 comprises a second active component different from the first active component. The second active component is typically a material that can store lithium species reversibly. In one embodiment, the second active component comprises Li₄Ti₅O₁₂.

At least one of the first and second electrodes 14, 16 further comprises an additive. Typically, the additive is present in at least the second electrode 16, more typically present in just the second electrode 16. The additive is useful for maintaining a potential of the cell 10 in a range of from about 0.5V to about 1.5V. The additive is also useful for preventing the potential of the cell 10 from dropping below about 0.5V. The additive is typically selected from the group of FeS₂, FeS, CuO, Cu₄O(PO₄)₂, MoO₂, WO₂, and combinations thereof. In one embodiment, the additive is FeS₂. The additive typically has a reaction potential with lithium of at least about 0.5V, more typically of from about 0.5V to about 1.5V, most typically of from about 1.0V to about 1.5V.

In certain embodiments, the second active material is active in lithium ion storage that composes the discharge process at 1V to 2V vs. lithium (Li). The additive reacts with lithium ions above 0.5V but at a potential lower than the second active material. The capacities of the additive and the second active material are balanced in such a way that the capacity of the first electrode 14 is larger than that of the second active material alone. However, the sum of the capacities of the additive and the second active material together is larger than the capacity of the first electrode 14.

The first and second electrodes 14, 16 may each further comprise a binder. The binder may be any binder known to those skilled in the battery art. The binder is typically selected from the group of polyvinyldifluoride (PVDF), styrene butadiene rubber (SBR), and combinations thereof. In one embodiment, the binder is PVDF. In one embodiment, the first and second electrodes 14, 16 each comprise PVDF.

The first and second electrodes 14, 16 may each further comprise a conducting aid. The conducting aid may be any conducting aid known to those of ordinary skill in the battery art, such as carbon black, graphite, etc. In one embodiment, the first and second electrodes 14, 16 each comprise the conducting aid, being as described as exemplified above.

A first current collector 18 is disposed in the housing 12. The first current collector 18 is in electrical communication with the first electrode 14. The first current collector 18 may be formed from various materials known to those skilled in the battery art, including, but not limited to, copper. In one embodiment, the first current collector 18 comprises aluminum. In a further embodiment, the first current collector 18 is aluminum foil. In other embodiments, the first current collector 18 comprises an aluminum alloy. In one embodiment, at least a portion of the first current collector 18 is coated with the first electrode 14. In other embodiments, at least a portion of the first current collector 18 is coated with the first active component.

A second current collector 20 is disposed in the housing 12 and is spaced from the first current collector 18. The second current collector 18 is in electrical communication with the second electrode 16. The second current collector 20 may be formed from various materials known to those skilled in the battery art, including, but not limited to, copper. In one embodiment, the second current collector 20 comprises aluminum. In a further embodiment, the second current collector 20 is aluminum foil. In other embodiments, the second current collector 20 comprises an aluminum alloy. In one embodiment, at least a portion of the second current collector 20 is coated with the second electrode 16. In other embodiments, at least a portion of the second current collector 20 is coated with the second active component and/or the additive.

In one embodiment, both the first and second current collectors 18, 20 are aluminum foil. This embodiment is especially useful for reducing manufacturing cost and weight of the cell 10. Further, the first and second current collectors 18, 20 are generally resistant to corrosion by nonconductive surface coatings, making the cell 10 generally safer than conventional lithium cells during over-discharging. In addition, the need to charge the cell 10 immediately after manufacture of the cell 10 may be omitted until the cell 10 needs to be charged for a first-time use by a consumer. It is believed that in certain embodiments, when aluminum foil is used for the second current collector 20 of the second electrode 16, the aluminum foil may react with lithium at potentials close to the lithium potential. Without being bound or limited by any particular theory, it is believed that such a reaction can be avoided by employing the additive and the first electrode 14-second electrode 16 balance, being as described and exemplified above.

A separator 22 is disposed in the housing 12 between the first and second electrodes 14, 16. Typically, the separator 22 is sandwiched between the first and second electrodes 14, 16 when they face each other. The separator 22 may be formed from various materials known to those of ordinary skill in the battery art. For example, the separator 22 may be a polyolefin membrane, such as micro-porous polyethylene, polypropylene, etc. As another example, the separator 22 may also be ceramic.

Typically, the cell 10 further comprises an electrolyte composition disposed in the housing 12. The electrolyte composition may be any electrolyte composition known to those skilled in the battery art. If the electrolyte composition is in the form of a liquid or gel, the separator 22 is typically placed between the first and second electrodes 14, 16 to prevent shorting and to retain the electrolyte composition.

Examples of suitable electrolyte compositions, for purposes of the present invention, include, but are not limited to; electrolyte solutions obtained by dissolving lithium salt in a non-aqueous solvent, the non-aqueous solvent may be a perfect liquid, perfect solid, or intermediate gel state; liquid electrolytes including alkyl carbonates, e.g. propylene carbonate and ethylene carbonate, dialkyl carbonates, cyclic ethers, cyclic esters, glymes, formates, esters, sulfones, nitrates, oxazolidinones, etc.; polymeric solid electrolytes, such as polyethylene oxide (PEO), polymethylene-polyethylene oxide (MPEO), PVDF or polyphosphazenes (PPE); and electrolyte salts including LiPF₆, LiClO₄, LiSCN, LiAlCl₄, LiBF₄, LiN(CF₃SO₂)₂, LiCF₃SO₃, LiC(SO₂CF₃)₃, LiO₃SCF₂CF₃, LiC₆F₅SO₃, LiCF₃CO₂, LiAsF₆, LiSbF₆, etc.

In embodiments employing the additive having a potential of at least about 0.5V, alternatively, at least about 1.0 V, reductive decomposition of the electrolyte composition during overcharging of the cell 10 is highly suppressed. Thus, a wide-range of choices of electrolyte compositions are possible, as described and exemplified above. Specifically, destabilizing reactions within the cell 10 are generally prevented during overcharging of the cell, and battery packs or systems implementing the cell 10 or cells 10 can be used without problem, even if overcharging of the cell 10 or cells 10 occurs.

The cells 10 of the present invention may have a wound structure, more typically, a laminated or a stacked structure. The structure typically comprises a plurality of the first and second electrodes 14, 16 and separators 22, for example, as illustrated in FIG. 1. The electrolytic composition may be poured into and/or onto the structure. The structure, the electrolytic composition, and the first and second current collectors 18, 20 are then sealed, i.e., encapsulated, by the housing 12. As shown in FIG. 1, the cell 10 further includes is a first feed-thru 24 and a second feed-thru 26 disposed in the openings of the first and second terminals of the housing 12, respectively. The first and second feed-thrus 24, 26 are in electrical communication with the first and second current collectors 18, 20, respectively, to communicate power to and from the cell 10. While one method of making the cell 10 is described above, it is to be appreciated that present invention is not limited to any particular method of making the cell 10.

The present invention has been described herein in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described within the scope of the appended claims.

What is claimed is:

1. A lithium cell suitable for use in a battery pack, said lithium cell comprising:
a housing;
a first electrode disposed in said housing and comprising a first active component;
a second electrode disposed in said housing spaced from said first electrode and having an opposite charge from said first electrode and comprising a second active component different from said first active component;
a first current collector disposed in said housing and in electrical communication with said first electrode;
a second current collector disposed in said housing spaced from said first current collector and in electrical communication with said second electrode;
a separator disposed in said housing between said first and second electrodes; and
an additive of at least one of said first and second electrodes for maintaining a potential of said lithium cell in a range of from about 0.5V to about 1.5V and for preventing the potential from dropping below about 0.5V.

2. A lithium cell as set forth in claim 1 wherein said additive is selected from the group of FeS₂, FeS, CuO, Cu₄O(PO₄)₂, MoO₂, WO₂, and combinations thereof.

3. A lithium cell as set forth in claim 2 wherein said additive has a reaction potential with lithium of at least about 0.5V.

4. A lithium cell as set forth in claim 2 wherein said additive has a reaction potential with lithium of from about 0.5V to about 1.5V.

5. A lithium cell as set forth in claim 2 wherein first active component of said first electrode comprises at least one of LiMn₂O₄, LiCoO₂, LiNiO₂, and LiFePO₄.

6. A lithium cell as set forth in claim 5 wherein said first electrode further comprises a binder and a conducting aid.

7. A lithium cell as set forth in claim 6 wherein said first current collector comprises aluminum and at least a portion of said first current collector is coated with said first electrode.

8. A lithium cell as set forth in claim 2 wherein said second active component of said second electrode comprises Li₄Ti₅O₁₂.

9. A lithium cell as set forth in claim 8 wherein said second electrode further comprises a binder and a conducting aid.

10. A lithium cell as set forth in claim 9 wherein said second current collector comprises aluminum and at least a portion of said second current collector is coated with said second electrode.

11. A lithium cell as set forth in claim 1 further comprising an electrolyte composition.

12. A lithium cell as set forth in claim 1 wherein said housing is an envelope of rectangular configuration having a first terminal and a second terminal opposite said first terminal and spaced by side edges with each of said first and second terminals defining at least one opening.

13. A lithium cell suitable for use in a battery pack, said lithium cell comprising:
a housing;
a first electrode disposed in said housing and comprising LiMn₂O₄;
a second electrode disposed in said housing spaced from said first electrode and having an opposite charge from said first electrode and comprising Li₄Ti₅O₁₂;
a first current collector disposed in said housing and in electrical communication with said first electrode and comprising aluminum;
a second current collector disposed in said housing spaced from said first current collector and in electrical communication with said second electrode and comprising aluminum; and
a separator disposed in said housing between said first and second electrodes;
wherein at least one of said first and second electrodes further comprises an additive for maintaining a potential of said lithium cell in a range of from about 0.5V to about 1.5V and for preventing the potential from dropping below about 0.5V.

14. A lithium cell as set forth in claim 13 wherein said additive is selected from the group of FeS₂, FeS, CuO, Cu₄O(PO₄)₂, MoO₂, WO₂, and combinations thereof.

15. A lithium cell as set forth in claim 14 wherein said additive has a reaction potential with lithium of from about 0.5V to about 1.5V.

16. A lithium cell as set forth in claim 13 wherein each of said first and second electrodes further comprises a binder and a conducting aid.

17. A lithium cell as set forth in claim 16 wherein said binder is selected from the group of polyvinyldifluoride (PVDF), styrene butadiene rubber (SBR), and combinations thereof.

18. A lithium cell as set forth in claim 13 wherein at least a portion of said first current collector is coated on said first electrode and at least a portion of said second current collector is coated with said second electrode.

19. A lithium cell as set forth in claim 13 further comprising an electrolyte composition.

20. A lithium cell as set forth in claim 13 wherein said housing is an envelope of rectangular configuration having a first terminal and a second terminal opposite said first terminal and spaced by side edges with each of said first and second terminals defining at least one opening.
